(19) United States
(12) Patent Application Publication
(10) Pub. No.: US 2008/0162992 A1
(43) Pub. Date: Jul. 3, 2008

(54) Method and apparatus for intelligently re-sequencing tests based on production test results

(76) Inventor: Wayne J. Lonowski, Fort Collins, CO (US)

Correspondence Address: VERIGY, LTD., IP LEGAL DEPARTMENT, 10100 N. TANTAU AVENUE, CUPERTINO, CA, 95014-2540, US

(21) Appl. No.: 11/645,921

(22) Filed: Dec. 27, 2006

(51) Int. Cl. G06F 11/22

(52) U.S. Cl. 714/25

(57) ABSTRACT

Techniques for sequencing tests in a test program include determination of failure detection efficiency for tests in a test program, and sequencing the tests into a test sequence wherein tests having higher associated failure detection efficiencies are sequenced before tests having lower associated failure detection efficiencies.

### BACKGROUND OF THE INVENTION

The present invention relates generally to mass production device testing, and more particularly to a novel technique for decreasing testing time by intelligently re-sequencing tests based on production test results.

During mass production of many devices, for example integrated circuit devices, the devices are tested for quality control purposes. Industrial testers of devices, for example along a manufacturing line, may run a number of different tests on each device. Depending on the complexity of both the device under test and the tests to be run on the device, the execution time for testing each device may be significant.

Industrial testers are typically very costly items. In production environments, it is often quite important to maximize the throughput of tested devices. However, when the test time for each device is high, testing may act as a bottleneck in the production process. As a result, test engineers often analyze production test data to determine the effectiveness of the various tests conducted. Less effective tests may be removed from the sequence of tests to be conducted, or may be re-sequenced to be executed only if a device under test passes other more effective tests. Historically, the job of analyzing production test data and re-sequencing, adding, or eliminating tests has been done manually and in a hand-crafted fashion by the production test engineer, relying heavily on the individual expertise of the engineer. This creates an inconsistent and unstructured approach to a critical task.

Accordingly, a need exists for a technique for improving the overall efficiency of the sequence of tests.

### SUMMARY OF THE INVENTION

Embodiments of the invention utilize test sequencing logic to re-sequence tests to improve and optimize testing efficiency.

In one embodiment, a method for sequencing tests in a test program includes steps of determining an associated failure detection efficiency for a plurality of the tests, sequencing the tests into a test sequence wherein tests having higher associated failure detection efficiencies are sequenced before tests having lower associated failure detection efficiencies, and modifying the test program to re-sequence the tests according to the test sequence.

In one embodiment, a computer readable storage medium tangibly embodying program instructions which, when executed by a computer, implement a method for sequencing tests in a test program, wherein the method includes steps of determining an associated failure detection efficiency for a plurality of the tests, sequencing the tests into a test sequence wherein tests having higher associated failure detection efficiencies are sequenced before tests having lower associated failure detection efficiencies, and modifying the test program to re-sequence the tests according to the test sequence.

In one embodiment, a test sequencing apparatus for sequencing tests in a test program of a device tester includes a test efficiency rater which generates failure detection efficiency ratings for tests in the test program, and test sequencing logic which sequences the tests into a test sequence wherein tests having higher associated failure detection efficiency ratings are sequenced before tests having lower associated failure detection efficiency ratings, and which modifies the test program to re-sequence the tests according to the test sequence.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of an automated test system;

FIG. 2 is a block diagram illustrating data flow in the test system of FIG. 1;

FIG. 3 is a structural diagram illustrating an example graphical sub-structure of a test program;

FIG. 4 is a structural diagram illustrating an example test program; and

FIG. 5 is a flowchart illustrating an exemplary method for dynamically re-sequencing tests of a test program.

### DETAILED DESCRIPTION

Embodiments of the invention utilize test sequencing logic to re-sequence tests to improve testing efficiency. Embodiments of the invention may optimize a sequence of tests over time to minimize overall testing time by sequencing tests that are most likely to fail earlier in the test program.

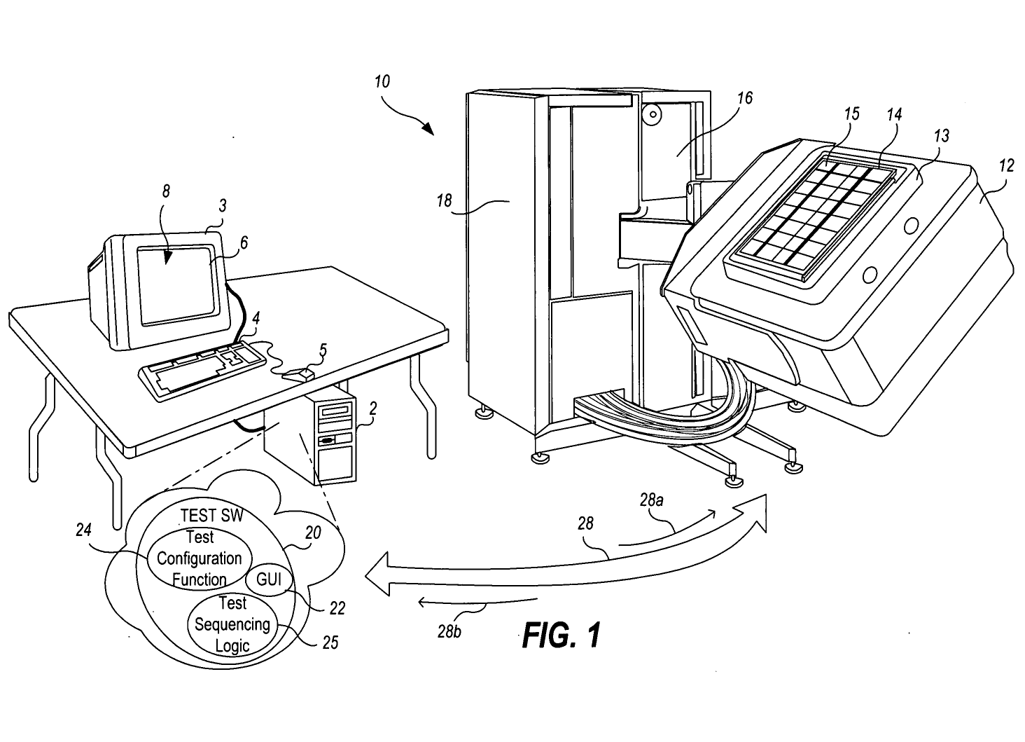

Turning now to the drawings, FIG. 1 is a view of an industrial tester 10. For purposes of illustration, the details of the tester 10 shall be discussed herein in terms of the test system 10 being an Verigy 93000 Systems-on-a-Chip (SOC) Series test system, manufactured by Verigy, Inc., of Palo Alto, Calif. However, it is to be understood that the novel features of embodiments described herein may be applied to any type of tester which tests groups of any type of device in test runs.

The test system 10 comprises a test head 12 for interfacing with and supplying hardware resources to a device under test (DUT) 15, a manipulator 16 for positioning the test head 12, a support rack 18 for supplying the test head 12 with power, cooling water, and compressed air, and a workstation 2.

The test head 12 inlcudes digital and analog electronic testing capabilities required to test the DUT, such as obtaining test measurements for parameters of interest of the DUTs. The test head 12 is connected to a DUT interface 13. The device under test (DUT) 15 may be mounted on a DUT board 14 which is connected to the tester resources by the DUT interface 13. The DUT interface 13 may be formed of high performance coax cabling and spring contact pins (pogo pins) which make electrical contact to the DUT board 14. The DUT interface 13 provides docking capabilities to handlers and wafer probers (not shown).

The test head 12 may be water cooled. It receives its supply of cooling water from the support rack 18 which in turn is connected by two flexible hoses to a cooling unit (not shown). The manipulator 16 supports and positions the test head 12. It provides six degrees of freedom for the precise and repeatable connection between the test head 12 and handlers or wafer probers. The support rack 18 is attached to the manipulator 16. The support rack 18 is the interface between the test head 12 and its primary supplies (AC power, cooling water, compressed air).

An operator may interact with the tester 10 by way of a computer or workstation (hereinafter referred to as “workstation”). The workstation 2 is the interface between the operator and the test head 12. Tester software 20 may execute on the workstation 2. Alternatively, tester software may execute in the test head 12 or another computer (not shown), where the workstation 2 may access the tester software remotely. In one embodiment, the workstation 2 is a high-performance Unix workstation running the HP-UX operating system or a high-performance PC running the Linux operating system. The workstation 2 is connected to a keyboard 4 and mouse 5 for receiving operator input. The workstation 2 is also connected to a display monitor 3 on which a graphical user interface (GUI) window 8 may be displayed on the display screen 6 of the monitor 3. Communication between the workstation 2 and the test head 12 may be via direct cabling or may be achieved via a wireless communication channel, shown generally at 28.

The tester software 20, which is stored as program instructions in computer memory and executed by a computer processor, comprises test configuration functionality 24 for configuring tests on the tester 10, and for obtaining test results. The tester software 20 also comprises GUI interface 22 which implements functionality for displaying test data. Test data may be in the form of any one or more of raw test data 28b received from the test head 12, formatted test data, summary data, and statistical data comprising statistics calculated based on the raw test data. GUI interface 22 may detect and receive user input from the keyboard 4 and mouse 5, and which generates the GUI window 8 on the display screen 6 of the monitor 3.

The tester software 20 allows download of setups and test data 28a to the test head 12. All testing is carried out by the test head 12, and test results 28b are read back by the workstation 2 and displayed on the monitor 3.

In one embodiment, the test software 20 is Verigy's SmarTest 93000 Series software. The SmarTest software includes a Test Editor which operates as test configuration functionality 24 to allow setting up a test program known in SmarTest as a “Testflow”. A “Testflow” is an interconnected set of individual tests, called Test Suites, each one testing a particular parameter. In SmarTest, Test Suites may be logically interconnected in a multitude of different ways—sequentially, dependent on the previous/another result, while something is valid, etc. Together, all these Test Suites form a complete test of a device. As used herein the term “test program” refers to any series of tests to be executed on a device under test in a particular order. A SmarTest Testflow is therefore a test program.

In one embodiment, where the tester software 20 is the Verigy SmarTest, the test configuration functionality 24 is called the Testflow Editor. The Testflow Editor provides menus and dialogues that allow an operator access to all provided functions for creating, modifying and debugging a Testflow. Testflows may be set up and executed through the Testflow Editor. Testflow icons are selected via mouse selection from within an Insert pulldown menu (not shown). Icons can be manipulated by highlighting icons in an existing testflow and using an Edit menu (not shown).

The tester software 20 includes test sequencing logic 25 which controls the sequencing of tests sent to the tester for execution.

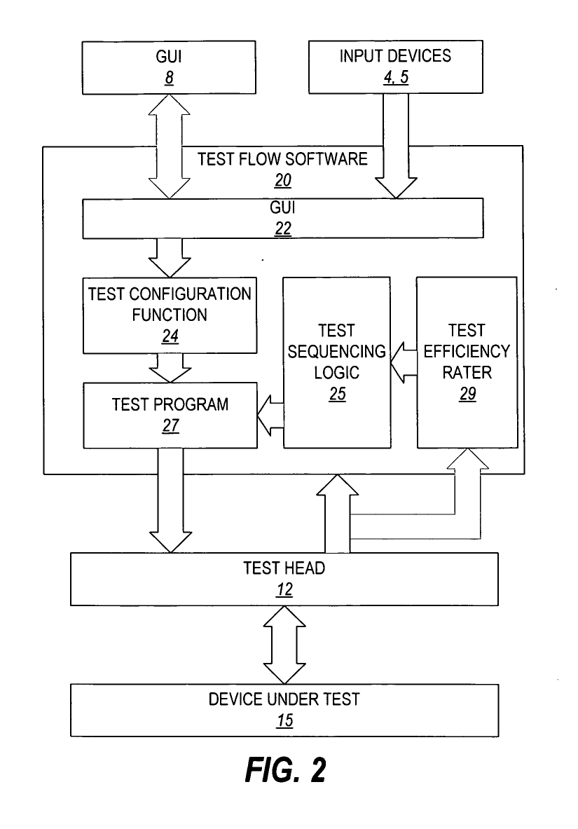

FIG. 2 is a block diagram illustrating data flow in the test system 10 of FIG. 1. As illustrated, the test software 20 includes the GUI interface 22 which presents the GUI window 8 to the operator (via display screen 6 of display 3). The GUI interface 22 collects operator input (via keyboard 4 and mouse 5) such as tester configuration information, test setup information, and tester instructions (for example instructing the tester to download test information and test data, or to initiate execution of a test program). Test configuration information is used by the test configuration function 24 of the test software 20 to generate a test program 27. The test head 12 performs tests of one or more DUTs 15 as instructed by the test program. The test software 20 collects test results 28b. Test sequencing logic 25 of the test software 20 determines (for example using a test efficiency rating function 29), or otherwise obtains, corresponding failure detection efficiency ratings for the tests in the test program.

As used herein, the term “failure detection efficiency” refers to how efficient a test is in terms of accuracy, speed, or frequency. In terms of accuracy, some tests may sometimes fail to detect a defective device, and/or may falsely identify a device as defective even though in fact the device is not defective. Such tests may be rated with a lower failure detection efficiency rating than tests that, for example, always fail defective parts and never report false failures. In terms of speed, some tests may run longer than others to determine whether a device is defective. Tests that can reveal a failure faster relative to other tests may be rated with a higher failure detection efficiency than tests that take longer to identify a failure. In terms of frequency, some tests may statistically generate failures more often than other failures (for example, because some types of failures may be much more common than others). Tests that statistically identify more defective devices may be rated with a higher failure detection efficiency rating than tests that statistically identify fewer defective devices. The overall failure detection efficiency of a given test may take into account one or more efficiency factors, which may include accuracy, speed, frequency, or other factors.

Based on test efficiency ratings, the test sequencing logic may make modifications to the sequence (e.g., order) in which the tests are executed in order to dynamically optimize the test program, as described hereinafter.

As described previously, the GUI interacts with the test configuration functionality 24 to generate a series of dialogues that allow the operator to set up a test program that includes a number of tests to be executed on devices under test. Configuration dialogues allow the operator to enter information regarding each device component to be tested and the parameters to be tested for the corresponding component. Configuration dialogues also allow the operator to set up test sequencing logic and an initial test sequence.

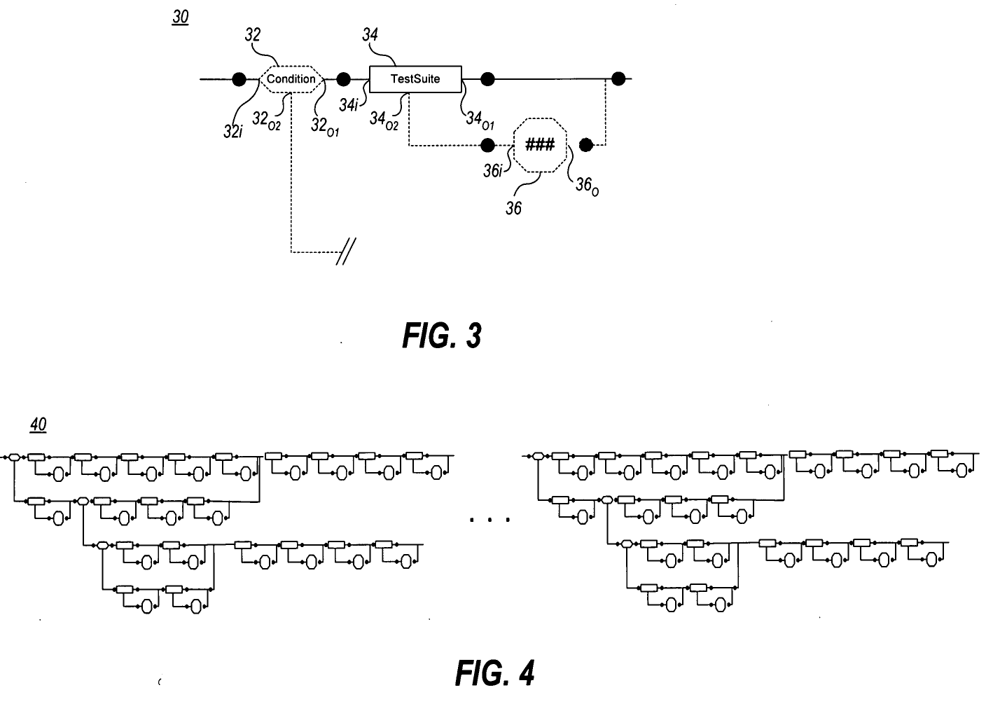

FIG. 3 illustrates an example graphical sub-structure 30 of a test program that may be generated by test configuration functionality 24.

In the particular embodiment shown, icons 32, 34, 36 are used to represent conditions 32, test suites 34, and bins 36, discussed hereinafter.

Each test suite icon 34, represented by a rectangular shape, represents an individual, independent, executable device test (a functional test, for example). The test may test a single parameter of a single component of the DUT 15, or may test a plurality of parameters of one or more components of the DUT 15. In the illustrative embodiment, the test flow can be made to be, or not to be, dependent on the results of another test. If a given test is not dependent on the results of another test, the give test is configured as a simple “run” test suite icon. If the given test is to be made dependent on the results (e.g., pass/fail) of another test, the given test is configured as a “run and branch” test icon. The “run” and “run and branch” test icons are presented herein for purposes of illustration only. Other test icon types beyond the scope of the present invention may be defined. Furthermore, the executable that the icon represents may be any type of executable.

Each bin icon 36, represented by an octagonal or a triangular shape, represents a number of devices that fall into a similar category. For example, in the illustrative embodiment, octagonal bins are storage bins for listing the device numbers of devices that fail a test associated with the bin. Of course, other bin icon types beyond the scope of the present invention may be defined, such as bins that store device identifiers of devices that pass the associated test and bins that store device identifiers of devices that have not yet been tested.

Each condition icon 32, represented by a hexagonal shape, represents a condition or set of conditions that determine the flow control of a branch, a while loop, a for loop, a repeat loop, or other flow control.

Each icon 32, 34, 36 includes an input 32ᵢ, 34ᵢ, 36ᵢ, and one or more outputs 32ₒ₁, 32ₒ₂, 34ₒ₁, 34ₒ₂, 36ₒ. The sequence of the test program is represented by connecting lines, or “connectors” between the outputs of the various icons and inputs of other icons. During execution of a test program, the test program executes an executable associated with an icon, and flow moves to the icon whose input is connected to its output. In the test program example shown, if more than one output exists, only one output will be selected. The selected output typically depends on the results of the executable represented by the icon. For example, referring to the condition icon 32 in FIG. 3, two outputs 32ₒ₁ and 32ₒ₂ exist. However, during execution of the test program, flow of the test program will pass to only one of the outputs 32ₒ₁ and 32ₒ₂, and the determination of which output the test program will follow depends on the results of a conditional test defined in the executable represented by the conditional control flow icon 32. Similarly, test suite icon 34 also has two outputs 34ₒ₁ and 34ₒ₂. During execution of the test program, the test program flows to only one of the outputs 34ₒ₁ and 34ₒ₂, depending on the results of a conditional test defined in the executable represented by the test suite icon 34. Since one of the outputs 34ₒ₂ is connected to the input of a failure bin 36, output 34ₒ₂ is selected if the test results indicate a failure on the component or pin tested by the executable represented by the test suite icon 34. Otherwise, output 34ₒ₁ is selected.

A typical test program may include hundreds of test suites. FIG. 4 is an example test flow map 40 of an example test program that may be generated by test flow software 30. As illustrated, the test flow map 40 includes a number of tests (represented by rectangular boxes), conditional tests (represented by hexagonal boxes), and bins (represented by octagonal boxes). Connectors between the test suites, conditional tests, and bins indicate the test flow of the test program.

A test program may be defined using the test configuration functionality 24. For example, a very simple test program may be as follows:

```
Begin TestProgram
  Begin Test1
    Execute Test1
  End Test1
  Begin Test2
    Execute Test2
  End Test2
  ...
  Begin Testn
    Execute Testn
  End Testn
End TestProgram
```

The above test program may be represented graphically as shown in FIG. 4.

When a test program executes, the sequencing of the tests to be executed may initially flow in the order specified in the test program setup (for excitation, as graphically represented in the test program Editor such as in FIG. 4).

In high volume production, devices are often tested only until they fail. Upon detection of any failure, the device may be considered defective and testing may terminate for that device. Accordingly, unless the device passes all tests except the last test in the test program, the full test program is not performed on a defective part. Rather, the part is tested until detection of a first failure, and then the device is rejected and testing moves on to a different device. Reduction in overall test time can thus be achieved by sequencing tests that fail most frequently first in the test program.

Embodiments of the invention employ test sequencing logic that analyzes test performance and re-sequences tests in the test program based on their test performance history. In particular, test sequencing logic may utilize test result statistics to intelligently and dynamically optimize the ordering of tests in a test program such that tests with higher failure detection efficiency are sequenced prior to tests with lower failure detection. The test sequencing logic may be configured to operate in realtime, on demand, or periodically.

As previously mentioned, test execution time is a major aspect of the cost of test that the tester realizes during the production lifecycle. Test sequencing logic may be employed to reduce the cost of test by dynamically and intelligently controlling test execution on a test by test basis. The reduction in test execution time may be realized by re-sequencing tests with low failure detection efficiency ratings to execute at, or near, the end of the test program.

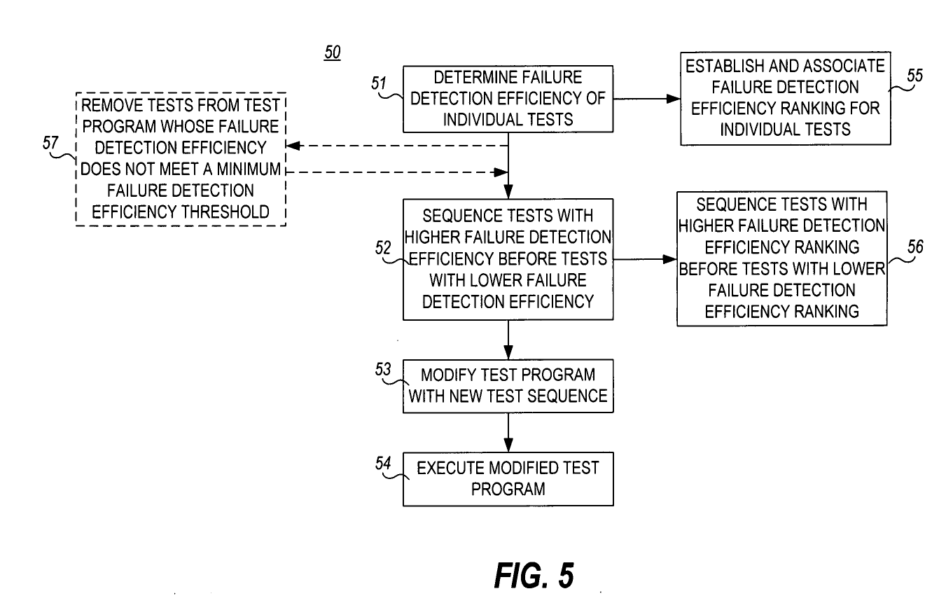

FIG. 5 is a flowchart illustrating an exemplary embodiment of a method 50 implementing test sequencing logic. In this method, the test sequencing logic determines an associated failure detection efficiency for a plurality of the tests (step 51) and sequences the tests into a test sequence wherein tests having higher associated failure detection efficiencies are sequenced before tests having lower associated failure detection efficiencies (step 52). The test program may be modified to re-sequence the tests according to the test sequence (step 53). The modified test program may then be executed (step 54). The method may be repeated to dynamically modify the test program based on realtime test results. Alternatively, the method may be performed to update the test program sequence after post-processing the failure information over some pre-determined quantity of tested devices (e.g., processing data on a lot-by-lot basis, after completion of the testing for that lot; or processing data on a limited initial batch run from a particular lot, then applying the resequenced test program to the remainder of the lot).

In one embodiment, test results associated with respective tests of the test program are analyzed to establish respective failure detection efficiency rankings associated with the respective tests (step 55). In one embodiment, the test sequencing logic sequences the tests such that tests with higher failure detection efficiency rankings are sequenced before tests with lower failure detection efficiency rankings (step 56).

In one embodiment, the test sequencing logic is implemented as program instructions that are executed by a processor.

An example pseudocode script illustrating a method implementing the test sequencing method of FIG. 5, is shown below:

```
BEGIN TestSequencingProgram
  ModifiedTestProgram := Null
  WHILE moreTests(TestProgram) == TRUE
    getNextTest(Test);
    TestEfficiency := GetFailureDetectionEfficiency(TestProgram,
    Test);
    InsertSorted(Test, TestEfficiency, ModifiedTestProgram)
  END WHILE
  TestProgram := ModifiedTestProgram;
END TestProgram
wherein:
        more Tests: function which determines whether any remaining
            unprocessed tests in a test program exist;
        getNextTest (Test): function returns the next test, in sequenced
            order, in a test program;
        GetFailureDetectionEfficiency(TestProgram, Test): function
            which returns a failure detection efficiency rating associated
            with the named test in the named test program; and
        InsertSorted(Test, TestEfficiency, ModifiedTestProgram):
            function which inserts the named test into the named
            ModifiedTestProgram in sorted order of highest to lowest
            efficiency ratings.
```

In one embodiment, determining the respective failure detection efficiencies of the tests in a test program may be achieved by monitoring how often each test detects a test failure, and assigning tests with higher failure detections as having higher failure detection efficiency. As stated previously, other factors such as test accuracy, test speed, and test statistics may be factored in to the efficiency rating of the tests as well.

Often, test specifications require that certain tests must be executed in order to pass (i.e., declare the device “good”) a given device under test. The test specifications may be set by contract with the customer, for example. In these situations, a test engineer does not have the discretion of removing tests that statistically provide very little information (for example, tests that statistically never or very rarely fail a device under test). Test time which would otherwise be reduced were the particular test to be removed cannot be reduced by removing the test from the test program. However, by using test re-sequencing logic in accordance with embodiments of the invention, such tests can be re-sequenced to the end of the test program so that they are only executed if all other tests pass. Thus, while such tests that provide very little information are not actually removed from the test program but merely re-positioned in the sequence of tests, the test time taken by execution of the test is only used if the part actually passes all tests with higher failure detection efficiency. Test re-sequencing therefore benefits the manufacturer of the devices since test time can be improved without requiring removal of any of the tests in the test program.

In other situations, certain tests in the test program may be removed by a test engineer. Test time may be improved by removing tests having low failure detection efficiency ratings. For example, tests that statistically never or very rarely fail a device under test would have a low failure detection efficiency rating and may be deemed of low value to the testing process. Tests with low efficiency ratings may be removed by the test engineer. In one embodiment, tests are automatically removed from the test program when their failure detection efficiency rating is less than a predetermined minimum failure detection efficiency threshold (step 57).

In summary, test re-sequencing minimizes overall test time consumed by defective devices under test (DUTs) by finding the failures earlier in the test sequence. When a device fails a test, the device is considered to be “defective”, and any tests remaining to be performed on the device need not be performed. The test re-sequencing tool is advantageous over prior art because it provides a systematic, structured approach to the task of catching failures quickly to minimize test times on failing parts, it reduces average test time, and provides a standardized supported tool.

Although this preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method for sequencing tests in a test program, comprising:
determining an associated failure detection efficiency for a plurality of the tests;
sequencing the tests into a test sequence wherein tests having higher associated failure detection efficiencies are sequenced before tests having lower associated failure detection efficiencies; and
modifying the test program to re-sequence the tests according to the test sequence.

2. The method of claim 1, further comprising:
executing the modified test program; and
repeating the determining step through modifying step.

3. The method of claim 1, wherein:
the determining step comprises analyzing test results associated with respective tests of the test program to establish respective failure detection efficiency rankings associated with the respective tests; and
the sequencing step comprises sequencing the tests such that tests with higher failure detection efficiency rankings are sequenced before tests with lower failure detection efficiency rankings.

4. The method of claim 1, comprising:
removing tests whose associated failure detection efficiency is below a predetermined minimum failure detection efficiency threshold.

5. The method of claim 1, wherein the test program comprises at least one non-removable test that may not be removed from the test program, and none of the non-removable tests are removed from the test program in the modified test program.

6. A computer readable storage medium tangibly embodying program instructions which, when executed by a computer, implement a method for sequencing tests in a test program, the method comprising:
determining an associated failure detection efficiency for a plurality of the tests;
sequencing the tests into a test sequence wherein tests having higher associated failure detection efficiencies are sequenced before tests having lower associated failure detection efficiencies; and
modifying the test program to re-sequence the tests according to the test sequence.

7. The computer readable storage medium of claim 6, the method further comprising:
executing the modified test program; and
repeating the determining step through modifying step.

8. The computer readable storage medium of claim 6, wherein:
the determining step comprises analyzing test results associated with respective tests of the test program to establish respective failure detection efficiency rankings associated with the respective tests; and
the sequencing step comprises sequencing the tests such that tests with higher failure detection efficiency rankings are sequenced before tests with lower failure detection efficiency rankings.

9. The computer readable storage medium of claim 6, the method comprising:
removing tests whose associated failure detection efficiency is below a predetermined minimum failure detection efficiency threshold.

10. The computer readable storage medium of claim 6, wherein the test program comprises at least one non-removable test that may not be removed from the test program, and none of the non-removable tests are removed from the test program in the modified test program.

11. A test sequencing apparatus for sequencing tests in a test program of a device tester, comprising:
a test efficiency rater which generates failure detection efficiency ratings for tests in the test program; and
test sequencing logic which sequences the tests into a test sequence wherein tests having higher associated failure detection efficiency ratings are sequenced before tests having lower associated failure detection efficiency ratings, and which modifies the test program to re-sequence the tests according to the test sequence.

12. The test sequencing apparatus of claim 11, wherein:
the test sequencing logic removes tests whose associated failure detection efficiency is below a predetermined minimum failure detection efficiency threshold.

13. The test sequencing apparatus of claim 12, wherein:
the test program comprises at least one non-removable test that may not be removed from the test program, and the test sequencing logic does not remove any of the non-removable tests from the test program.
